(19) United States
(12) Patent Application Publication
(10) Pub. No.: US 2025/0362338 A1
(43) Pub. Date: Nov. 27, 2025

(54) METHOD AND SYSTEM FOR THERMAL-AWARE ELECTROMIGRATION EVALUATION AND CIRCUIT DESIGN

(71) Applicant: TAIWAN SEMICONDUCTOR MANUFACTURING COMPANY, LTD., Hsinchu (TW)

(72) Inventors: Chun-Wei CHANG, Hsinchu (TW); Wei-Ming CHEN, Hsinchu (TW); Hsien YU TSENG, Hsinchu (TW); Ming-Hong HSIEH, Hsinchu (TW)

(21) Appl. No.: 18/672,481

(22) Filed: May 23, 2024

(51) Int. Cl. G01R 31/28; G06F 30/28; G06F 30/398; G06F 119/02; G06F 119/08

(52) U.S. Cl. CPC G01R 31/2858; G06F 30/28; G06F 30/398; G06F 2119/02; G06F 2119/08

(57) ABSTRACT

A method includes identifying a structure of interest in an IC design; assigning a thermal affected zone to a region of the IC design encompassing at least a portion of the structure of interest; identifying a plurality of structures that are, in whole or in part, in the thermal affected zone and that correspond to IC device elements that self-heat during operation of an IC device that is based on the IC design; modeling a corresponding plurality of operating temperatures for the plurality of structures and identifying, among the plurality of operating temperatures, a highest temperature; identifying, among the plurality of structures, a structure having the highest temperature as a first neighboring structure; assigning a rating factor based on a distance between the structure of interest and the first neighboring structure; and modeling an operating temperature of the structure of interest based on the highest temperature and the rating factor.

### BACKGROUND

An electric current passing through a conductive line can induce electromigration (EM), i.e., the movement of atoms (of which the conductive line is made) due to momentum transfer between electrons (the electric current passing through the conductive line) and the atoms. In a metal line, electromigration can, over time, cause the formation of hillocks (accumulation of excess metal) and/or voids (depletion of initial metal) in the metal line, which, in turn, can result in short circuits (hillocks) or open circuits (voids).

A mean time to failure (MTTF) for conductive lines caused by electromigration is estimated by taking into consideration a number of operative factors including, e.g., the sizings of the conductive lines, the composition of the conductive lines, the microstructure of the conductive lines, the current density carried by the conductive lines, the duty cycles over which the current is applied to the conductive lines, and the operating temperatures of the conductive lines. Electromigration evaluation, analysis, and signoff methodologies applied to a particular integrated circuit (IC) design attempt to take at least some of the operative factors into consideration in order to provide an estimate regarding the lifetime of IC devices manufactured using the IC design to avoid premature failure of the IC devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a process of electromigration within a metal wire.

FIG. 2 is a schematic view of thermal coupling between components, in accordance with some embodiments.

FIGS. 3A and 3B are schematic views of thermal coupling between conductive lines, in accordance with some embodiments.

FIG. 4 is a schematic view of an electromigration tool useful in the operation of an electromigration sign-off methodology, in accordance with some embodiments.

FIG. 5 is a flow chart of a method of calculating an increase in temperature of a conductive line due to heating from one or more neighboring conductive lines, in accordance with some embodiments.

FIG. 6 is a flow chart of a method for conducting an electromigration evaluation, in accordance with some embodiments.

FIG. 7 is a schematic view of an electronic design automation system useful in the operation of an electromigration sign-off methodology, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

IC devices such as semiconductor devices tend to increase in temperature during operation as a result of self-heating effects (SHE). These self-heating effects tend to limit both the performance capability and the operational lifetime of the affected IC devices. For example, self-heating effects in IC devices, e.g., self-heating in active structures (such as transistors or active regions) or other resistive structures, tend to reduce device performance and reliability.

Accordingly, some IC designs utilize conductive lines and interconnecting vias as heat dissipation conduits for controlling temperature. This technique for dissipating heat, however, increases the operating temperature of the conductive lines. The heat from active structures or other resistive structures, when coupled with inherent current/resistance (IR) heating (also referred to as ohmic or joule heating) of conductive lines, increases the risk of accelerated electromigration-related failures in the conductive lines. Device designers seek to address the risk of increased electromigration in the conductive lines to some degree by modifying the IC design and/or operational parameters, but such design compensations tend to reduce the density, reduce the performance, and/or increase the size of the resulting IC device.

FinFET-based IC devices tend to provide power, performance, and area benefits over planar transistor-based semiconductor devices. The FinFET-based IC designs, however, tend to exhibit greater local current densities which, in turn, lead to greater concern for electromigration failures in the conductive lines forming signal and power rail interconnections within the FinFET-based IC devices.

In some instances, a FinFET-based semiconductor device includes a substrate that includes an active region (AR), in which a source and drain are formed, and a guard ring, a plurality of conductive line layers separated by layers of interlayer dielectric (ILD) materials, and vias formed through the ILD materials to establish electrical connections to and between the conductive line layers. Depending on the particular IC design, heat generated within an active region reaches a conductive line that neighbors the active region, e.g., by thermal transmission through intervening layers, or by thermal transmission through connecting vias, conductive lines, or the like.

Heat dissipation paths available in FinFET IC designs are limited by the fin structure. Thus, there are regions and/or structures within the IC design in which the self-heating effects result in increased operating temperatures that can increase the likelihood of accelerated electromigration degradation. In some IC designs, a temperature increase of 10° C. in a conductive line can increase an electromigration degradation of the conductive line by 50%, e.g., a temperature increase of 10° C. in the conductive line can degrade the specification of the conductive line from a 1 microampere (μA) specification to a 0.5 μA specification. The concerns regarding self-heating effects tend to increase for the reduced structural dimensions associated with more advanced processes and/or high-speed/high-performance IC designs.

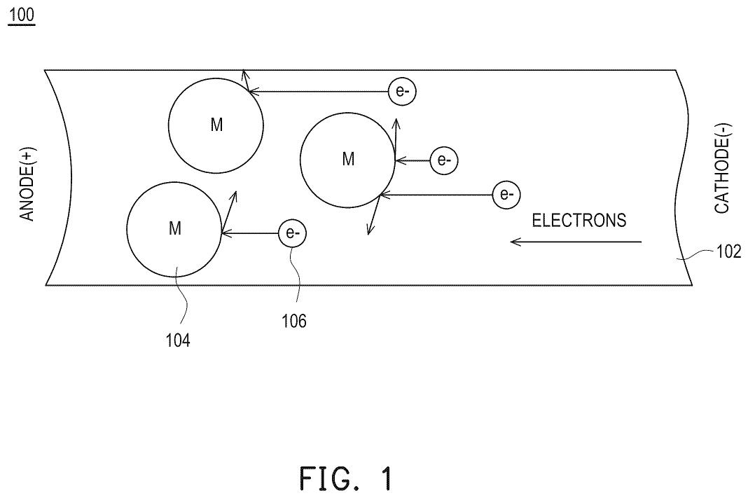

FIG. 1 is a schematic view of a process of electromigration within a conductive line.

Referring to FIG. 1, electromigration can occur when an electrical current flows through a conductive line, e.g., a metal line, and the electrons transfer a portion of their momentum to the atoms, e.g., metal atoms, in the conductive line, thereby tending to urge the metal atoms in the direction of the electron flow.

In FIG. 1, conductive line 100 includes a conductive line segment 102 including a plurality of atoms 104 (e.g., atoms of aluminum (Al), copper (Cu), titanium (Ti), tantalum (Ta), tungsten (W), platinum (Pt), cobalt (Co), nickel (Ni), or the like) or atoms of alloying elements such as nitrogen (N), silicon (Si), or the like. The conductive line 102 is a conductive path for electrons 106 moving between a cathode and an anode. Repeated transfers of momentum from the electrons 106 to the atoms 104 during operation of an IC device can gradually shift the metal atoms 104 from their original positions, thereby increasing the non-uniformity of the conductive line 102.

In those regions of the conductive line 100 in which the movement of the atoms 104 reduces the cross-section of the conductive line 100, the current density will increase and further exacerbate both the self-heating effects and electromigration in the thinned regions. A conductive line 100 having such thinned regions can exhibit increased resistance and/or reduced performance, and the conductive line 100 can eventually degrade to cause a void or an open circuit. Conversely, in those regions of the conductive line 100 in which the movement of the atoms 104 increases the cross-section of the conductive line 100, the thickened regions, e.g., hillocks, can stress surrounding materials and eventually compromise the structural integrity of the surrounding materials, and/or create a short-circuit to an adjacent conductive line or another conductor.

To help reduce or eliminate electromigration-induced failures, design rules associated with a manufacturing process include electromigration rules to limit an average current density through the conductive line 100, and to take into consideration the temperature of the conductive line 100 during operation of the IC device, including temperature contributions from self-heating in the conductive line 100. IC designs that pass applicable electromigration rules are approved for electromigration signoff and tape-out.

Additional self-heating effects can be modeled or estimated to increase the temperature of a transistor structure by a particular amount AT. At least a portion of the self-heating effects that produce the AT will, in turn, be transferred to a neighboring conductive lines, e.g., through direct contact with the transistor, via conduction through intervening materials (e.g., ILD materials or layers), or the like. In some embodiments, in addition to self-heating effects associated with transistors and/or active regions, other high-resistance (Hi-R) structures (e.g., resistors or the like) in the IC device contribute additional heating the neighboring conductive line.

Electromigration evaluation methodologies that do not identify and compensate for the increased operating temperature of the conductive line 100 have an increased risk of underestimating the operating temperature of the conductive line 100. Underestimating the operating temperature of the conductive line 100 can produce an electromigration evaluation result that is overly optimistic, lead to overestimating the average lifetime of IC devices manufactured to that design, and/or result in premature field failures of the affected IC devices.

In order to improve electromigration evaluation, electromigration evaluation should identify and consider those portions of an IC design in which self-heating effects are expected to increase the operating temperature of at least a portion of a conductive line.

In some embodiments, an electromigration evaluation includes using equation-based device temperature calculations, using a thermal model for estimating thermal coupling range(s) and effect(s), generating an estimated conductive line temperature, and conducting an electromigration confirmation check at the estimated conductive line temperature, to thus compensate for self-heating effects and improve the accuracy of the electromigration evaluation.

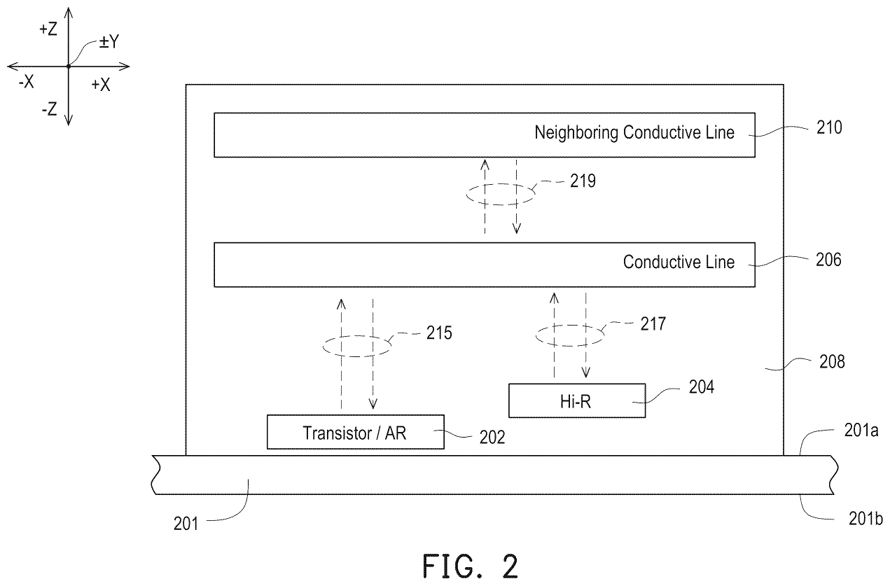

FIG. 2 is a schematic view of thermal coupling between components, in accordance with some embodiments.

In FIG. 2, a semiconductor structure 200 includes a substrate 201 (e.g., a semiconductor substrate). The semiconductor structure 200 also includes a transistor/AR structure 202, a Hi-R structure 204, a conductive line 206 (the conductive line of interest CLi), and a neighboring conductive line 210 (CLn), all embedded in an ILD structure 208.

In FIG. 2, the transistor/AR structure 202, the Hi-R structure 204, the conductive line of interest 206, the neighboring conductive line 210, and the ILD structure 208 are arranged over a first surface 201a of the substrate 201. In other embodiments, one or more of the transistor/AR structure 202, the Hi-R structure 204, the conductive line 206, the neighboring conductive line 210, the ILD structure 208, and the like are arranged below a second surface 201b of the substrate 201. In other embodiments, one or more of the transistor/AR structure 202, the Hi-R structure 204, the conductive line 206, the neighboring conductive line 210, the ILD structure 208, and the like are arranged both over the first surface 201a and below the second surface 201b of the substrate 201. In some embodiments, one or more of the transistor/AR structure 202, the Hi-R structure 204, the conductive line 206, the neighboring conductive line 210, the ILD structure 208, and the like are arranged within the substrate 201.

An electromigration evaluation according to some embodiments includes consideration of thermal effects on the conductive line of interest CLi (which is, in FIG. 2, the conductive line 206) from: (i) heat from the transistor/AR structure 202, (ii) heat from the Hi-R structure 204 (e.g., a resistor or the like), (iii) self-heating in the conductive line 206 itself, and (iv) heat from the neighboring conductive line CLn (which, in FIG. 2, is the conductive line 210). In some embodiments, the thermal effects considered during the electromigration evaluation include bi-directional heat-transfer effects between structures.

During IC device operation, the transistor/AR structure 202 and the Hi-R structure 204 can generate heat (through self-heating) that is transferred to the adjacent conductive line 206. Accordingly, in some embodiments, an electromigration evaluation for the conductive line 206 takes into consideration heat that is generated in the adjacent transistor/AR structure 202 and the Hi-R structure 204. As IC devices scale to more advanced technology nodes, the conductive line 206 becomes smaller in cross-section and, as such, can also self-heat. Likewise, the neighboring conductive line CLn can self-heat or otherwise increase in temperature.

Some advanced IC designs include one or more of a back-side circuit structure (e.g., a power structure such as a super power rail, an interconnect structure, or the like on a backside of a semiconductor substrate opposite to a frontside of the semiconductor substrate where active regions are formed), an appended wafer substrate for mechanical support (e.g., a carrier substrate, that is incorporated into the final IC), one or more stacked dies, and the like that impede heat dissipation and/or replace structures that other IC designs have used as heat sinks, thereby increasing the number of potential heat sources while reducing structures that serve to reduce device temperatures. Additionally, bonding layers, e.g., for bonding backside circuit structures, appended support substrates, stacked dies, and the like to the IC substrate, can impede heat flow out of the IC device. Also, some advanced IC designs incorporate thinned substrates, which are less efficient as heat sinks than unthinned substrates.

According to some embodiments, an electromigration evaluation for a conductive line of interest CLi takes into consideration heat from transistors/active regions and Hi-R structures, self-heating in the conductive line itself, and heat from neighboring conductive lines CLn.

FIG. 2 schematically illustrates thermal coupling 215 whereby heat from the transistor/AR structure 202 can be transferred to the conductive line 206 via thermal coupling through the ILD structure 208 and/or other intermediate materials, and heat from the conductive line 206 can be transferred to the transistor/AR structure 202. Similarly, thermal coupling 217 represents heat transfer between the Hi-R structure 204 and the conductive line 206, and thermal coupling 219 represents heat transfer between the conductive line 206 and the neighboring conductive line 210. In FIG. 2, the Hi-R structure 204 is between the substrate 201 and the conductive line 206, but in other embodiments the Hi-R structure 204 is in a layer above the conductive line 206 such that the conductive line 206 is between the Hi-R structure 204 and the substrate 201, and thermal coupling 217 is evaluated above the conductive line 206.

FIG. 2 schematically illustrates thermal coupling 215, 217, 219 oriented normal to the substrate 201 (+Y and −Y directions), for ease of illustration, but the thermal coupling 215, 217, 219 and heat transfer act in three dimensions from a heat source.

In some embodiments, the cumulative thermal effects of self-heating and heat transfer are used to calculate an estimated temperature for the conductive line 206 that is used for electromigration evaluation of the conductive line 206.

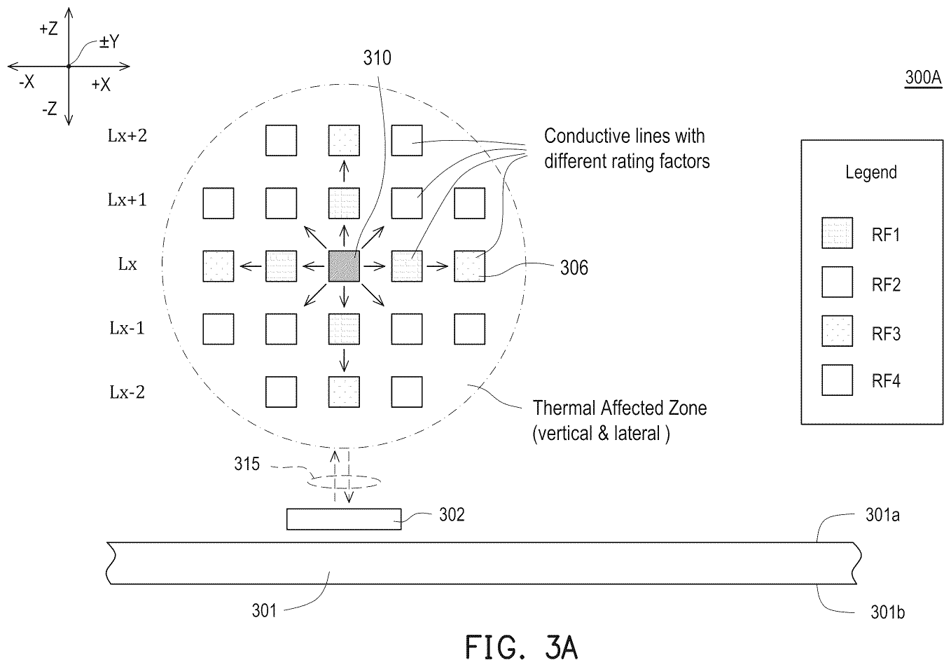

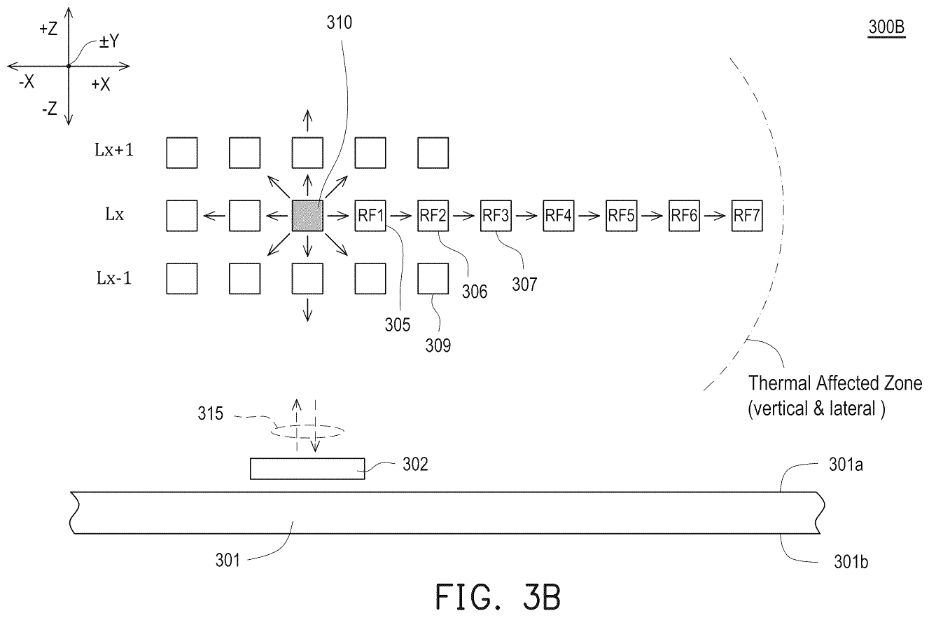

FIG. 3A is a schematic view of thermal coupling between conductive lines, in accordance with some embodiments.

In some embodiments, a thermal model defines a Thermal Affected Zone (TAZ). The thermal model evaluates features of interest (e.g., conductive lines) around a heat source (e.g., a hot conductive line) in the TAZ. By way of example, in FIG. 3A the TAZ surrounds conductive lines including a conductive line 306, in a layer Lx, that is a conductive line of interest CLi. In the TAZ, a neighboring conductive line 310, in the layer Lx, is considered to be the heat source. In some embodiments, the neighboring conductive line 310 is determined or modeled to be a structure in the TAZ that reaches a highest temperature during operation of the IC device.

In FIG. 3A, the size of the TAZ is determined using distance to assign the size to the TAZ. In some embodiments, distance is used as one factor among two or more factors to assign the size of the TAZ. For example, in some embodiments the size of the TAZ assigned is based on lateral or vertical distances, based on differences in layers, or the like. In FIG. 3A, the TAZ is circular in the X-Z plane. In some embodiments, the TAZ is circular in the X-Y plane or another plane. In some embodiments, the TAZ is spherical. In some embodiments, the TAZ has a different dimension along the X or Y axis than the Z axis. In some embodiments, the TAZ has different dimensions along each of X, Y, and Z axes. In some embodiments, the TAZ is about 0.5 μm or less for a 2 nm technology node.

In FIG. 3A, a semiconductor structure 300A includes a transistor/AR/Hi-R structure 302, the conductive line 306, and the neighboring conductive line 310. For clarity, a single transistor/AR/Hi-R structure 302 is shown but it will be understood that a plurality of transistor, active region, and Hi-R structures is included in the semiconductor structure 300A in some embodiments. For clarity, the semiconductor structure 300A does not include the ILD (see FIG. 2) but it will be understood that the ILD and/or other layers cover and/or surround the transistor/AR/Hi-R structure 302, the conductive line 306, and the neighboring conductive line 310 in some embodiments.

In FIG. 3A, the thermal model is used to evaluate conductive lines in the TAZ around the neighboring conductive line 310, which is the heat source. The conductive lines in the TAZ, e.g., the conductive line 306, are evaluated for the thermal impact from the heat source, i.e., from the neighboring conductive line 310) over a first surface 301a of a substrate 301. In other embodiments, the thermal model is used to evaluate one or more transistors/ARs/Hi-R structures 302 around the neighboring conductive line 310. The one or more transistors/ARs/Hi-R structures 302 in the TAZ are evaluated for the thermal impact from the heat source.

In FIG. 3A, the TAZ is in an X-Z plane over the substrate 201. In some embodiments, the TAZ is defined in another plane, or in three dimensions as a sphere, cylinder, cube, rectangular solid, or the like. In some embodiments, the TAZ is defined under the substrate 301 or encompassing the substrate 301. In FIG. 3A, the TAZ is circular in the X-Z plane, is centered on the neighboring conductive line 310 in the layer Lx, and encompasses features in layers Lx+2 to Lx−2. In other embodiments, the TAZ larger in diameter and/or is centered on a feature in a layer below the layer Lx (e.g., the layers Lx−1 or Lx−2, or a layer closer to the substrate 310 than layer Lx−2) and encompasses one or more transistors/ARs/Hi-R structures 302.

FIG. 3A schematically illustrates thermal coupling 315 (as arrows in FIG. 3A) oriented in an X-Z plane over a substrate 301, for ease of illustration, but the thermal coupling and heat transfer act in three dimensions from a heat source and in some embodiments are evaluated in three dimensions.

In FIG. 3A, the TAZ includes the conductive line 306, the neighboring conductive line 310, and nineteen other locations that can be conductive lines, for a total of twenty-one conductive line locations in the TAZ. In an example electromigration evaluation, the conductive line 306 is evaluated for temperature increase as a result of heat generated by the neighboring conductive line 310. That is, the neighboring conductive line 310 is considered to be the heat source and the conductive line 306 is evaluated for an increase in temperature as a result of heat transferred to the conductive line 306 from the heat of the neighboring conductive line 310. In some embodiments, each conductive line in any of the twenty locations in the TAZ surrounding the neighboring conductive line 310 are evaluated for heat effects from heat of the neighboring conductive line 310. In other embodiments, the TAZ is larger and/or centered in a layer under the layer Lx, and each conductive line and each of transistors/ARs/Hi-R structures 302 in the TAZ are evaluated for heat effects from a heat source in the TAZ, e.g., at the center of the TAZ.

In FIG. 3A, twenty conductive line locations are each assigned a rating factor (RF) relative to the heat source (i.e., relative to the neighboring conductive line 310), the rating factors corresponding to an influence, on each location, of heat transferred from the neighboring conductive line 310 acting as a heat source.

In some embodiments, the TAZ is divided into sub-zones and each sub-zone is assigned a rating factor. In some embodiments, the TAZ is divided into sub-zones based on distances. In some embodiments, the TAZ is divided into sub-zones based on distances from a heat source, e.g., the neighboring conductive line 310, or based on distances from a temperature-affected structure, e.g., the conductive line 306.

In some embodiments, the rating factor indicates a temperature rise ratio relative to the heat source. In some embodiments, a lower rating factor indicates a relatively greater heating influence (i.e., a relatively greater temperature rise ratio), and a higher rating factor indicates a relatively lower heating influence (i.e., a relatively lower temperature rise ratio).

In FIG. 3A there are four rating factors: RF1, RF2, RF3, and RF4 by way of example. In FIG. 3A, the conductive line 306 is assigned a rating factor RF3.

Conductive lines in the TAZ (or transistors/ARs/Hi-R structures 302, when encompassed by the TAZ) with a rating factor of RF1 will tend to experience a greater rise in temperature due to heat from the neighboring conductive line 310 (the heat source) than conductive lines (or transistors/ARs/Hi-R structures 302) with a rating factor of RF2. Conductive lines (or transistors/ARs/Hi-R structures 302) with a rating factor of RF2 will tend to experience a greater rise in temperature due to heat from the neighboring conductive line 310 than conductive lines (or transistors/ARs/Hi-R structures 302) with a rating factor of RF3. Conductive lines (or transistors/ARs/Hi-R structures 302) with a rating factor of RF3 will tend to experience a greater rise in temperature due to heat from the neighboring conductive line 310 than conductive lines (or transistors/ARs/Hi-R structures 302) with a rating factor of RF4.

As an example, in FIG. 3A, assuming that the neighboring conductive line 310 is the heat source and the conductive line 306 is being evaluated for increase in temperature due to heat from the neighboring conductive line 310, and assuming that the temperature of the neighboring conductive line 310 is normalized to 1, then the conductive line 306 experiences a temperature increase of 1×RF3 due to heat transfer from the neighboring conductive line 310. More particularly, for an example in which temperature is measured in degrees centigrade or degrees Celsius (° C.) and RF3 represents a temperature rise ratio of 0.6, then the conductive line 306 experiences a temperature rise of 0.6° C. for each 1.0° C. rise in temperature of the neighboring conductive line 310. In this case, the conductive line 306 would experience a 6° C. temperature increase if the neighboring conductive line 310 experienced a 10° C. temperature increase ((10° C.×RF3)=(10° C.×0.6)=6° C.).

The conductive line 306, having rating factor RF3, will exhibit a greater rise in temperature due to heat from the neighboring conductive line 310 than will a conductive line having a rating factor of RF4, and will exhibit a lesser rise in temperature due to heat from the neighboring conductive line 310 than will a conductive line having a rating factor of RF1 or RF2.

In FIG. 3A, the TAZ encompassing twenty-one conductive line locations is merely an example. In some embodiments, the TAZ is larger or smaller, and encompasses a greater or fewer number of possible structure locations. In another example, the TAZ encompasses front end of line features on the substrate 310 such that transistors/ARs/Hi-R structures 302 are evaluated as in layer Lx−1, and the transistors/ARs/Hi-R structures 302 are assigned the rating factors RF1˜RF4. In another example, the TAZ encompasses front end of line features on the substrate 310 such that transistors/ARs/Hi-R structures 302 are evaluated as in layer Lx−1, and the transistors/ARs/Hi-R structures 302 are assigned rating factors or RF4 or higher, such that a closest transistor/AR/Hi-R structure 302 is assigned RF4, a next-closest transistor/AR/Hi-R structure 302 is assigned RF5, a second-next-closest transistor/AR/Hi-R structure 302 is assigned RF6, and the like. In another example, a Hi-R structure 302 is in a back end of line layer above the neighboring conductive line 310, e.g., in the layer Lx+1 or Lx+2, such that the neighboring conductive line 310 is between the Hi-R structure 302 and the substrate 301, the Hi-R structure 302 extends for multiple pitches to experience a temperature rise ratio of, e.g., 0.9, and the Hi-R structure 302 is assigned a high rating factor, e.g., RF0 or RF1. Also, the use of four rating factors RF1˜RF4 within the TAZ is merely an example. In some embodiments, a greater or fewer number of rating factors is assigned.

In some embodiments, the rating factors are assigned based on a distance from the heat-generating reference structure (which is the neighboring conductive line 310 in FIG. 3A). In some embodiments, the rating factors are assigned based on combination of the distance from the heat-generating reference structure and other factors, e.g., thermal conductivity of intervening structures or the like.

In some embodiments, each increase in rating factor indicates a uniform decrease in heating influence from the heat-generating reference structure. In other embodiments, each increase in rating factor indicates a decrease in heating influence from the heat-generating reference structure, but the decreases in heating influence are not uniform.

In FIG. 3A, merely by way of example, the rating factors are assumed to be assigned in an X-Z plane, i.e., in X and Z directions. In some embodiments, the rating factors are assigned based on a two-dimensional analysis of the design of the semiconductor structure in a plane other than the X-Z plane. In some embodiments, the rating factors are assigned based on a three-dimensional analysis of the design of the semiconductor structure. In some embodiments, the rating factors are assigned based on empirical evaluation or thermal modeling of an IC design.

In some embodiments, the rating factors are assigned such that a same change in rating factor, e.g., from RF1 to RF2, indicates a same change in the influence of heat transferred from the neighboring heat source regardless of the direction of heat transfer. In other embodiments, the rating factors have a directional component and are assigned such that a same change in rating factor, e.g., from RF1 to RF2, indicates a same change in the influence of heat transferred from the neighboring heat source in a lateral direction (X or Y axis) (e.g., with a layer) but a different (e.g., greater or lesser) change in the influence of heat transferred from the neighboring heat source in a vertical direction (Z axis) (e.g., from another layer). For example, heat transfer in the vertical direction may be greater or lesser than heat transfer in the lateral direction. In other embodiments, a same change in rating factor indicates a greater or lesser change in the influence of heat transferred from the neighboring heat source in each of three dimensions.

FIG. 3B is a schematic view of thermal coupling between conductive lines, in accordance with some embodiments.

In FIG. 3B, a semiconductor structure 300B includes a conductive line 305 between the conductive line 306 and the neighboring conductive line 310. Also, a conductive line 307 is on an opposite side of the conductive line 306 from the conductive line 305, and a conductive line 309 is below the conductive line 306.

In FIG. 3B there are seven rating factors (rating factors RF1, RF2, RF3, RF4, RF5, RF6, and RF7) by way of example. A lower rating factor indicates a relatively greater heating influence (i.e., a relatively greater temperature rise ratio), and a higher rating factor indicates a relatively lower heating influence (i.e., a relatively lower temperature rise ratio). Conductive lines with a rating factor of RF1 will tend to experience a greater rise in temperature due to heat from the neighboring conductive line 310 (the heat source) than conductive lines with a rating factor of RF2. Similarly, conductive lines with a rating factor of RF2 will tend to experience a greater rise in temperature due to heat from the neighboring conductive line 310 than conductive lines with a rating factor of RF3, conductive lines with a rating factor of RF3 will tend to experience a greater rise in temperature due to heat from the neighboring conductive line 310 than conductive lines with a rating factor of RF4, and so on.

In some embodiments, the rating factors RF1, RF2, RF3, RF4, RF5, RF6, and RF7 are assigned by pitch. In some embodiments, the pitch is a contacted poly pitch (CPP). In some embodiments, the CPP corresponds to a center-to-center distance along the X or Y axis between two immediately adjacent gate regions (two gate regions are considered immediately adjacent where there are no other gate regions therebetween). In some embodiments, the CPP is a fundamental unit of measure that has a specific value or range of values for the corresponding semiconductor process technology node. The sizes and/or placement of many other structures in a layout diagram and/or IC device, e.g., conductive lines, can be normalized relative to the CPP.

In some embodiments, the size of the TAZ in a lateral direction is assigned based on a number of CPP. In some embodiments, the size of the TAZ in a vertical direction is assigned to be equal to the size of the TAZ in the lateral direction that is determined based on the number of CPP. In some embodiments, the size of the TAZ in a vertical direction is based on a number of layers and the size of the TAZ in the lateral direction is determined based on the number of CPP.

In some embodiments, distance is used as one factor among two or more factors to assign the size of the TAZ. For example, in some embodiments the size of the TAZ is assigned based on lateral or vertical distances, based on differences in layers, or the like. In some embodiments, the TAZ is circular in the X-Z plane or another plane. In some embodiments, the TAZ is spherical. In some embodiments, the TAZ has a different dimension along the X or Y axis than the Z axis. In some embodiments, the TAZ has different dimensions along each of X, Y, and Z axes.

In some embodiments, relative to the neighboring conductive line 310 that is the heat source, the rating factors RF1, RF2, RF3, RF4, RF5, RF6, and RF7 progressively increase by increments of one (i.e., RF1 to RF2, RF2 to RF3, and so on) in a lateral direction (parallel to the X or Y axis) within a same layer (e.g., within a first metal layer M0 above a metal-to-diffusion (MD), within a second metal layer M1 that is over the first metal layer M0, within a third metal layer M3 that is over the second metal layer M2, or the like).

In some embodiments, relative to the neighboring conductive line 310 being the heat source, the rating factors RF1, RF2, RF3, RF4, RF5, RF6, and RF7 progressively increase by increments of one (i.e., RF1 to RF2, RF2 to RF3, and so on) for each CPP in the lateral direction (parallel to the X or Y axis) within the same layer (i.e., RF1 is 1 CPP from the neighboring conductive line 310, RF2 is 2 CPP from the neighboring conductive line 310, RF3 is 3 CPP from the neighboring conductive line 310, and so on), as shown in Table 1 below.

TABLE 1

| | |
|---|---|
| RF1 | 1 CPP |
| RF2 | 2 CPP |
| RF3 | 3 CPP |
| RF4 | 4 CPP |
| RF5 | 5 CPP |
| RF6 | 6 CPP |
| RF7 | 7 CPP |

In some embodiments, increments in the rating factors represent progressively smaller ratios of heating influence, as shown in Table 2 below.

TABLE 2

| | |
|---|---|
| RF1 | 0.74 |
| RF2 | 0.62 |
| RF3 | 0.55 |
| RF4 | 0.50 |
| RF5 | 0.45 |
| RF6 | 0.40 |
| RF7 | 0.39 |

Using Table 2 as an example, and assuming the neighboring conductive line 310 experiences a 10° C. temperature increase, locations of conductive lines 305, 306, and 307 are modeled to experience corresponding temperature increases of 7.4° C., 6.2° C., and 5.5° C. due to heat transfer from the neighboring conductive line 310, as shown in Table 3 below.

TABLE 3

| | | |
|---|---|---|
| Conductive line 305 | RF1 | 7.4° C. |
| Conductive line 306 | RF2 | 6.2° C. |
| Conductive line 307 | RF3 | 5.5° C. |

In another example based on Table 2, and referring to FIG. 3B, a conductive line at a location intermediate to locations with specific rating factors is assigned an intermediate rating factor. For example, in some embodiments, a conductive line 309, which is farther from the neighboring conductive line 310 than the conductive line 306 and closer to the neighboring conductive line 310 than the conductive line 307, is assigned a rating factor between RF2 and RF3, and is modeled to experience a temperature increase between that of the conductive line 306 and the conductive line 307 (e.g., the conductive line 309 is modeled to experience a temperature increase less than 6.2° C. and greater than 5.5° C.). In the preceding example, the intermediate rating factor was modeled solely based on distance. In other embodiments, the intermediate rating factor is modeled based on one or more of distance, a difference in layers, a difference in materials, or the like. In some embodiments, a conductive line or other structure at a location intermediate to locations with specific rating factors is assigned a rating factor that is the same as an adjacent location, e.g., the conductive line 309 is assigned the rating factor RF2 or the rating factor RF3.

Some examples above describe the first rating factor RF1 as representing a decrease in temperature from the heat source, e.g., the conductive line 305 is modeled to experience a temperature that is less than the temperature of the neighboring conductive line 310. However, in some embodiments, the rating factors are assigned starting from unity, such that the first rating factor RF1 is 1, e.g., the conductive line 305 is modeled to experience a temperature that is the same as the temperature of the neighboring conductive line 310. In some embodiments, the rating factors range from a temperature rise ratio of 1.0 to 0.1. In other embodiments, the unity rating factor is assigned as RF0, and the rating factor RF1 is less than unity.

In some embodiments, a temperature rise for a conductive line of interest CLi due to heat transferred from a neighboring conductive line CLn (which acts as a heat source relative to the conductive line of interest CLi) is calculated using Equation 1, below:

$$Δ {T}_{CLi ( n )} = {T}_{CL ( n )} \times RF \qquad [ Eq . 1 ]$$

$$Δ {T}_{CLi ( n )} : temperature rise for a conductive line of interest ( CLi ) due to heat transferred from a neighboring conductive line ( CLn ) acting as a heat source$$

$${T}_{CL ( n )} : temperature of neighboring conductive line CL ( n )$$

$$RF : rating factor , the temperature rise ratio relative to the neighboring conductive line CL ( n )$$

In an implementation of Eq. 1, for an example in which the rating factor RF represents a temperature rise ratio of 0.6, and the neighboring conductive line 310 (CLn) experiences a 10° C. temperature increase (T_{CL(n)}=10° C.), the temperature rise for the conductive line 306 as the conductive line of interest (CLi) is calculated as ΔT_{CLi(n)}=6° C. (6° C.=10° C.×0.6).

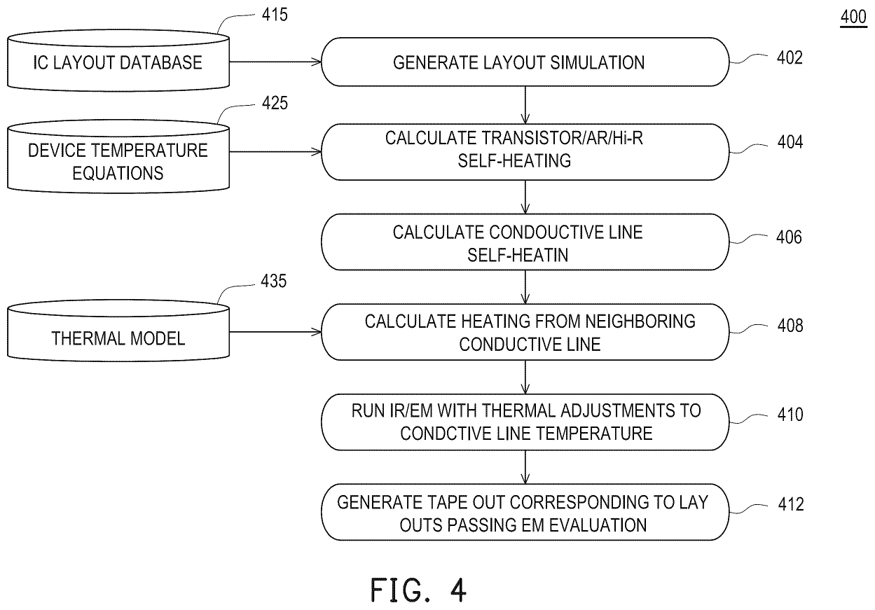

FIG. 4 is a schematic view of an electromigration tool 400 useful in the operation of an electromigration sign-off methodology, in accordance with some embodiments.

In some embodiments, referring to FIG. 4, the electromigration tool 400 includes a layout database 405 or a data storage device for storing design data corresponding to an IC layout.

The design data from the layout database 405 is used in a layout simulation operation 402 to generate a simulated design layout. The simulated design layout includes one or more heat-generating structures, e.g., transistors, active regions, Hi-R structures, conductive lines, and the like. As described in detail below, the simulated design layout from the layout simulation operation 402 will be used in combination with device temperature equations 425, which in some embodiments are retrieved from a memory, to calculate an overall increase in temperature for a conductive line of interest CLi.

In some embodiments, the simulated design layout is used in operations following operation 402 to calculate heat contributions from the heat-generating structures, in combination with device temperature equations 425 that are functions of, e.g., thermal resistance values, number of transistor fins in a FinFET, transistor or Hi-R structure power dissipation, or the like. In some embodiments, the relevant values and/or parameters included in the device temperature equations 425 are provided by a foundry, incorporated in the applicable design rules, extracted from an IC layout, or the like. In some embodiments, the device temperature equations 425 are provided as part of a design tool, e.g., a Simulation Program with Integrated Circuit Emphasis (SPICE) model corresponding to a particular manufacturing process, provided by a foundry or the like.

In some embodiments, the electromigration tool 400 next performs an operation 404 of calculating self-heating in one or more transistors, one or more active regions, and/or one or more Hi-R structures. In some embodiments, the heat contribution from an active region is determined as a function of the individual heat contribution calculations for each transistor or other active structure in the active region. In some embodiments, a cumulative heat contribution from a plurality of active regions is used in subsequent calculations for evaluating the magnitude of thermal impact of the active regions on a conductive line of interest CLi.

Next, the simulated design layout from the layout simulation operation 402 is used in combination with the device temperature equations 425 to calculate a modeled increase in temperature for a conductive line of interest CLi due to self-heating in the conductive line of interest CLi (operation 406). In some embodiments, Iᵣₘₛ is specified layer by layer. For example, rather than specifying a single Iᵣₘₛ value of, e.g., 5° C., for each layer, layers that are robust against electromigration are assigned a higher Iᵣₘₛ value of, e.g., up to 20° C., e.g., layer M0 and layers immediately adjacent to M0 are assigned higher Iᵣₘₛ values than layers spaced farther from layer M0. In some embodiments, Iᵣₘₛ is also specified by layer material, with layer materials that are more robust against electromigration being assigned a higher Iᵣₘₛ value. For example, rather than specifying a specifying a single Iᵣₘₛ value regardless of the material in the layer, layers made from materials with higher activation energies (Ea) are assigned higher Iᵣₘₛ values, e.g., a cobalt, ruthenium, or molybdenum layer is assigned a higher Iᵣₘₛ value than a copper or tungsten layer. Thus, in some embodiments, more robust layers are thus provided with a larger electromigration margin in operation 406. In some embodiments, Iᵣₘₛ is a function of metal width and ΔT.

Next, using a thermal model 435, which in some embodiments is retrieved from a memory, the electromigration tool 400 calculates a modeled increase in temperature of the conductive line of interest CLi due to heating from one or more neighboring conductive lines CLn identified in the IC layout (operation 408). In some embodiments, the thermal model 435 and Eq. 1 (discussed above) are used to determine or model an increase in temperature of the conductive line of interest CLi due to heating from one or more neighboring conductive lines CLn.

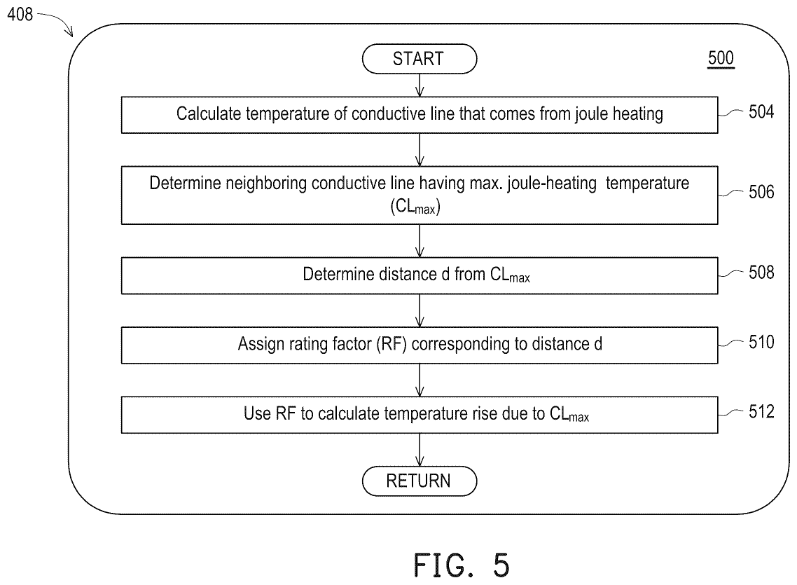

In some embodiments, in performing operation 408, the electromigration tool 400 performs a method 500 of FIG. 5 one or more times when calculating the increase in temperature of the conductive line of interest CLi due to heating from neighboring conductive lines CLn identified in the IC layout (i.e., in some embodiments, the operation 408 includes one or more iterations of the method 500.)

FIG. 5 is a flow chart of a method 500 of calculating an increase in temperature of a conductive line of interest CLi due to heating from one or more neighboring conductive lines CLn, in accordance with some embodiments.

The method 500 includes operations 504, 506, 508, 510, and 512. In some embodiments, operation 408 of FIG. 4 includes performing each of operations 504, 506, 508, 510, and 512 one or more times.

In FIG. 5, operation 504 includes calculating a temperature of each conductive line that comes from joule heating of the conductive line itself. In some embodiments, this includes modeling or computing a current-resistance (IR) temperature rise in each conductive line in the TAZ due to current passing through the resistance of conductive line during operation of the IC device.

Next, operation 506 includes determining a neighboring conductive line CLn having a maximum joule-heating temperature (CLₘₐₓ). In some embodiments, operation 506 includes defining or assigning a TAZ, importing a TAZ from the thermal model 435, or the like. In some embodiments, operation 506 includes locating the TAZ such that a conductive line of interest CLi is centered along one or more of X, Y, and Z axes in the TAZ.

In some embodiments, determining CLₘₐₓ includes evaluating each conductive line that neighbors the conductive line of interest CLi within the TAZ. In some embodiments, determining CLₘₐₓ includes evaluating each conductive line that extends to any extent within the TAZ. In some embodiments, determining CLₘₐₓ includes evaluating each conductive line that is fully within the TAZ.

Next, operation 508 includes determining a distance d from the neighboring conductive line CLn having the maximum joule-heating temperature (CLₘₐₓ).

Next, operation 510 includes assigning a rating factor corresponding to the distance d. In some embodiments, operation 510 includes assigning a rating factor described above in connection with FIGS. 3A and 3B.

In FIG. 5, operation 508 and 510 include determining the distance d and using the distance d to assign the rating factor. In some embodiments, distance is used as one factor among two or more factors to assign the rating factor. For example, in some embodiments the rating factor is assigned as described above in connection with FIGS. 3A and 3B, e.g., based on lateral or vertical distances, based on differences in layers, or the like.

Next, operation 512 includes using the rating factor to calculate the temperature rise due to the neighboring conductive line CLn having the maximum joule-heating temperature (CLₘₐₓ). In some embodiments, operation 512 includes performing a calculation corresponding to Eq. 1 to determine or model a temperature rise for the conductive line of interest CLi due to heat transferred from the neighboring conductive line CLn having the maximum joule-heating temperature (CLₘₐₓ) as a heat source.

In some embodiments, after operation 512, the method 500 repeats one or more cycles of operations 504˜512, e.g., for another conductive line of interest CLi and/or another neighboring conductive line CLn. In some embodiments, the method 500 is performed a plurality of times to calculate the temperature rise of a plurality of conductive lines of interest CLi. In some embodiments, the electromigration tool 400 performs an electromigration analysis 410 of FIG. 4 after the method 500 ends.

In some embodiments, in the electromigration analysis 410, the thermal model 435 provides a number of coefficients, e.g., a, b, c, d, specific to materials and/or layers incorporated in the IC design under analysis and/or the particular manufacturing process that will be used to produce devices according to the IC design. In other embodiments, the coefficients and/or other relevant values and/or parameters are provided by a foundry, incorporated into applicable design rules, or extracted from an IC layout.

In some embodiments, in the electromigration analysis 410, an overall temperature rise ΔTₛᵤₘ for a conductive line of interest CLi is a function of, e.g., an addition of, temperature rise contributions from (i) heat transferred to the conductive line of interest CLi from self-heating in one or more transistors, one or more active regions, and/or one or more Hi-R structures (operation 404), (ii) self-heating in the conductive line of interest CLi (operation 406), and (iii) heat transfer to the conductive line of interest CLi from self-heating in one or more neighboring conductive lines CLn (operation 408). In some embodiments the overall temperature rise ΔTₛᵤₘ is also a function of (iv) heat transferred to the conductive line of interest CLi from one or more other structures, e.g., other active structures such as bipolar junction transistors (BJT), diodes, or the like.

In some embodiments, the overall temperature rise ΔTₛᵤₘ for a conductive line of interest CLi is calculated according to Equation 2A, below:

$$Δ {T}_{sum} = f ( a , b , Δ {T}_{AR} , Δ {T}_{Hi - R} ) + Δ {T}_{rms} + Δ {T}_{CLi ( n )} \qquad [ Eq . 2 A ]$$

$$Δ {T}_{sum} : overall temperature rise for a conductive line of interest CLi$$

$$a : a de - rating coefficient reflecting operation at less than maximum capacity$$

$$b : a function of Δ {T}_{rms} and Δ {T}_{AR} [ f ( Δ {T}_{rms} , Δ {T}_{AR} ) ] ( thermal coefficients a and b are provided for each layer and / or material )$$

$$Δ {T}_{AR} : transistor / active region self - heating$$

$$Δ {T}_{Hi - R} : Hi - R structure self - heating$$

$$Δ {T}_{rms} : current - induced metal heating ( i . e . , heat from {I}_{rms} ) in the conductive line of interest CLi$$

$$Δ {T}_{CLi ( n )} : temperature rise due to heat transferred from a neighboring conductive line CLn acting as a heat source$$

In some embodiments, in Eq. 2A, ΔTᵣₘₛ is the self-heating in the conductive line of interest CLi from operation 406.

In some embodiments, in Eq. 2A, ΔT_{CLi(n)} is the heat transfer to the conductive line of interest CLi from self-heating in one or more neighboring conductive lines CLn from operation 408. In some embodiments, ΔT_{CLi(n)} is calculated using Eq. 1.

In some embodiments, the overall temperature rise ΔTₛᵤₘ for a conductive line of interest CLi is calculated according to Equation 2B, below:

$$Δ {T}_{sum} = f ( a , b , Δ {T}_{AR} , Δ {T}_{Hi - R} , c , d ) + Δ {T}_{rms} + Δ {T}_{CLi ( n )} \qquad [ Eq . 2 B ]$$

$$c : a layer effect associated with the layer / material$$

$$d : a temperature profile associated with the layer / material ( thermal coefficients c and d are provided for each layer and / or material )$$

In some embodiments, the overall temperature rise ΔTₛᵤₘ for a conductive line of interest CLi is calculated according to Equation 2C, below:

$$Δ {T}_{Con} = f ( a , b , Δ {T}_{AR} , Δ {T}_{Hi - R} , c , d , Δ {T}_{other \_ structures} ) + Δ {T}_{rms} + Δ {T}_{CLi ( n )} \qquad [ Eq . 2 C ]$$

$$Δ {T}_{other \_ structures} : self - heating from other structures ( other structures include , e . g . , \\ bipolar junction transistors ( BJT ) , diodes , and the like that are thermally coupled to the conductive line of interest CLi )$$

In some embodiments, the calculation of the overall temperature rise ΔTₛᵤₘ for a conductive line of interest CLi includes one or more factors representing effects of heat sink structures. Such heat sink structures include, e.g., temperature-reducing structures surrounding and/or adjacent to the conductive line of interest CLi, temperature-reducing structures surrounding and/or adjacent to the transistor(s), active region(s), Hi-R structure(s), and/or neighboring conductive line(s) CLn, other back-end structures, back-side structures, and the like. In some embodiments, the calculation of the overall temperature rise ΔTₛᵤₘ using such factors provides a more precise modeled or expected operating temperature that takes into account both heating and cooling effects of structures in the IC device.

In some embodiments, operation 410 includes revising an electrical current specification of the conductive line of interest CLi and generating a revised IC design layout that includes the revised electrical current specification. In some embodiments, one or more of operations 404˜408 are repeated for the revised IC design layout. In some embodiments, after the electromigration analysis 410, the electromigration tool 400 then generates a tape-out data file 418 corresponding to an IC layout that passes the electromigration analysis, i.e., that is signed-off.

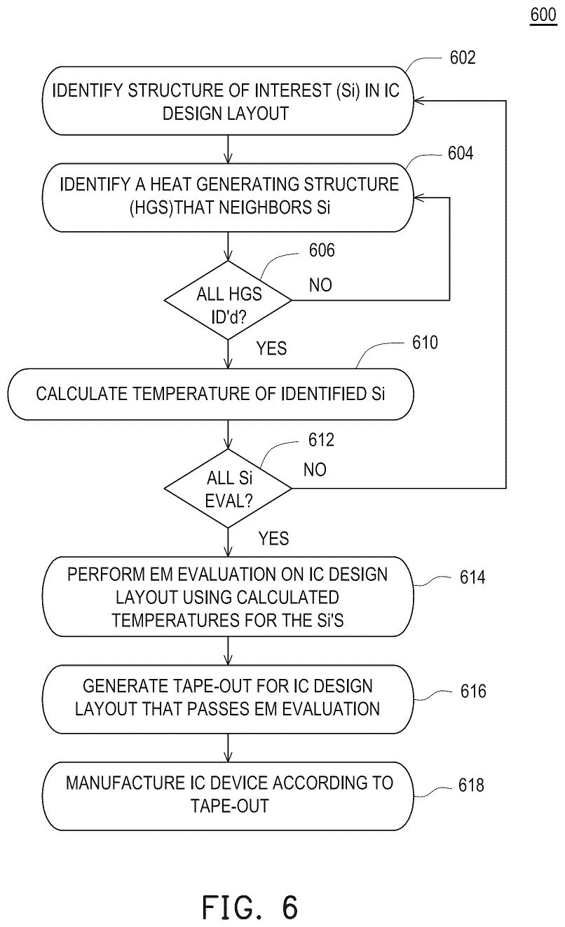

FIG. 6 is a flow chart of a method 600 for conducting an electromigration evaluation, in accordance with some embodiments.

In some embodiments, the method 600 improves the accuracy of electromigration evaluations conducted in connection with IC design by taking into account potentially degrading effects (e.g., performance limitations due to electromigration concerns) of increasing temperatures resulting from heat-generating structures.

In operation 602 of FIG. 6, a structure of interest (Si) is identified. In some embodiments, the structure of interest Si is identified by a structural and/or operational review of an IC design layout that is under evaluation. In some embodiments, the structure of interest Si is a conductive line of interest CLi as described above. In other embodiments, the structure of interest Si is another structure, e.g., a front end or back end structure such as a transistor, an active region, a Hi-R structure, or the like, that is evaluated for potential increases in temperature that could degrade performance and/or lifetime.

In operation 604, a neighboring structure is evaluated for identification as a heat-generating structure (HGS). In some embodiments, the heat-generating structure HGS is a transistor, an active region, or a Hi-R structure that increases in temperature due to self-heating. In some embodiments, the heat-generating structure HGS is a neighboring conductive line CLn that increases in temperature due to self-heating. In some embodiments, the heat-generating structure HGS is another structure such as a bipolar junction transistor (BJT), a diode, or the like.

In some embodiments, a conductive line is considered to be neighboring, and thus identified as a heat-generating structure HGS in operation 604, if the conductive line is located, in whole or in part, in a thermal affected zone TAZ, e.g., a thermal affected zone TAZ as described above in connection with FIGS. 3A-B.

In some embodiments, another neighboring structure other than a conductive line (e.g., a transistor, an active region, a Hi-R structure, or the like) is considered to be neighboring, and thus identified as a heat-generating structure HGS in operation 604, if such other structure is located, in whole or in part, in the thermal affected zone TAZ. In other embodiments, different thermal zones are assigned for one or more of such other structures. For example, whereas a conductive line is evaluated as a heat-generating structure HGS if the conductive line is in the TAZ, in some embodiments a transistor is evaluated as a heat-generating structure HGS if the transistor is in a thermal zone that differs in one or more of shape, dimension (2D or 3D), or size from the TAZ.

In some embodiments, operation 604 includes a filtering operation that excludes structures from consideration if modeled or expected temperatures for such structures are lower than a predetermined threshold.

In operation 606, if fewer than all of the heat-generating structures HGS have been identified, then the method 600 branches from operation 606 to repeat operation 604 and identify another heat-generating structure HGS. If all of the heat-generating structures HGS have been evaluated, then the method 600 continues to operation 610.

In operation 610, the method 600 includes calculating the temperature of the structure of interest Si. In the case that the structure of interest Si is a conductive line of interest CLi, operation 610 also includes determining a temperature increase in the conductive line of interest CLi from self-heating, e.g., determining ΔTᵣₘₛ from any of Eq. 2A-C. In some embodiments, operation 610 includes calculating the overall temperature rise ΔTₛᵤₘ for the conductive line of interest CLi according to any of Eq. 2A˜C. In the case that the structure of interest Si is a structure other than a conductive line (e.g., front end or back end structure such as a transistor, an active region, a Hi-R structure, or the like), in some embodiments operation 610 includes one or more operations similar to operations 504˜512.

In operation 612, if fewer than all of the structures of interest Si have been evaluated, then the method 600 branches from operation 612 to repeat operation 602 and evaluate another structure of interest Si. If all of the structures of interest Si have been evaluated, then the method 600 continues to operation 614.

In operation 614, the calculated temperature of the structure of interest Si is used in performing an electromigration evaluation to determine whether or not the IC design layout under evaluation satisfies lifetime and/or performance goals for the particular IC design. In some embodiments, operation 614 includes revising an electrical current specification of the structure of interest Si and generating a revised IC design layout that includes the revised electrical current specification. In some embodiments, one or more of operations 602˜612 are repeated for the revised IC design layout.

In some embodiments, for an IC design layout that passes the electromigration evaluation of operation 614, sign-off is complete and a tape-out data file corresponding to the passing IC design layout is generated in operation 616.

In some embodiments, following the electromigration evaluation of operation 614, a revised IC design layout is generated. In some embodiments, one or more operations of the method 600 are repeated on the revised IC design layout.

In some embodiments, the tape-out data file is used to manufacture an IC device, e.g., a semiconductor device such as memory, a processor, or the like, according to the passing IC design layout or a revised IC design layout, in operation 618.

Taking self-heating effects into consideration during an electromigration evaluation helps to prevent an IC design layout from being characterized as more resistant to electromigration effects than the corresponding IC device will actually achieve in operation. Embodiments help to improve performance and prevent premature field failures of the IC devices. By improving the accuracy of the IC design layout analysis, embodiments increase the confidence that IC devices manufactured according to a particular IC design layout are optimized for performance and provide an extended lifetime.

The efficiency of electromigration signoff methodologies considering the thermal effects of a particular IC design layout is improved by utilizing equation-based thermal evaluations, thereby avoiding slower, more time-consuming and computationally-demanding thermal modeling. The efficiency of some embodiments of the signoff methodologies is further improved by evaluating thermal coupling between various components including both front-end of line (FEOL) and back-end of line (BEOL) structures.

In some embodiments, the electromigration methodologies detailed above are applied to any IC design layout and/or IC or semiconductor device manufacturing process in which self-heating effects are expected to be a factor. In some embodiments, the IC design layouts correspond to FinFET-based semiconductor devices and/or other planar transistor-based or structurally-complex semiconductor devices.

In some embodiments, executing a heat sink-aware electromigration evaluation utilizes an electronic design automation (EDA) tool (also referred to as electronic computer-aided design (ECAD) tool) that identifies and evaluates structures within the IC design layout. In some embodiments, the EDA tool is configured to identify heat sources and/or heat sinks in an IC design layout from an IC design layout database. In some embodiments, the IC design layout database utilizes Open Artwork System Interchange Standard (OASIS) or another language for representing the IC design layout.

In some embodiments, an electromigration sign-off methodology provides more accurate local temperature calculations inside the IC design layout. In some embodiments, an electromigration sign-off methodology provides more accurate thermal-aware electromigration evaluation results during the design phase. In some embodiments, an electromigration sign-off methodology provides reduced risk of premature product failure and/or overdesign. In some embodiments, an electromigration sign-off methodology provides reduced simulation runtime using equation-based device temperature calculations. In some embodiments, an electromigration sign-off methodology provides reduced electromigration emulation runtime using thermal models.

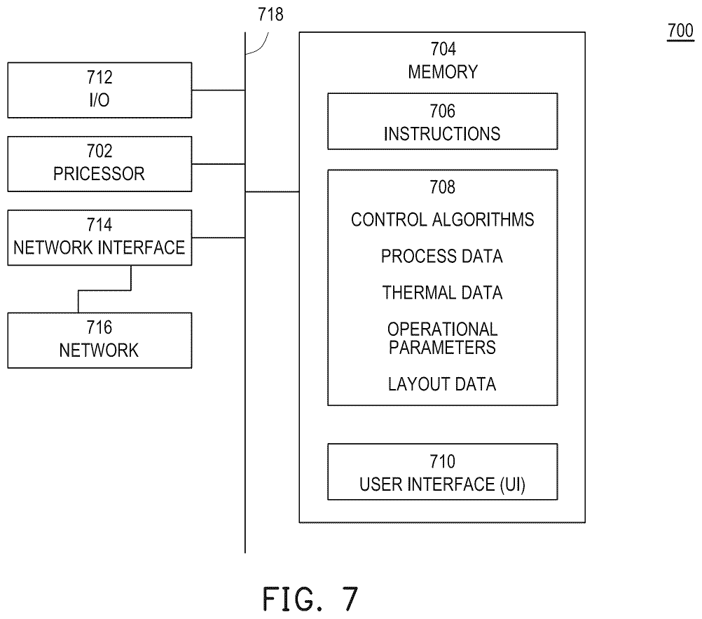

FIG. 7 is a block diagram of an electronic design automation (EDA) system 700, in accordance with some embodiments.

Methods described herein of electromigration evaluation, in accordance with some embodiments, are implementable using, e.g., the EDA system 700, in accordance with some embodiments. In some embodiments, the EDA system implements or includes an electromigration tool in accordance with some embodiments

In some embodiments, the EDA system 700 is a general-purpose computer including a hardware processor 702 and a non-transitory, computer-readable storage medium 704. The computer-readable storage medium 704, amongst other things, is encoded with, i.e., stores, computer program code (or instructions) 706, i.e., a set of executable instructions. Execution of computer program code 706 by the processor 702 represents (at least in part) an EDA tool that implements a portion or all of, e.g., the methods described herein in accordance with some embodiments (hereinafter, the noted processes and/or methods).

The processor 702 is electrically coupled to the computer-readable storage medium 704 via a bus 718. The processor 702 is also electrically coupled to an I/O interface 712 via the bus 718. A network interface 714 is also electrically connected to the processor 702 via the bus 718. The network interface 714 is connected to a network 716. The processor 702 and the computer-readable storage medium 704 connect to external elements via network 716. The processor 702 is configured to execute computer program code 706 encoded in the computer-readable storage medium 704 in order to cause the EDA system 700 to be usable for performing a portion or all of the noted processes and/or methods. In some embodiments, the processor 702 is a central processing unit (CPU), a multi-processor, a distributed processing system, an application-specific IC (ASIC), and/or a suitable processing unit.

In some embodiments, the computer-readable storage medium 704 is an electronic, magnetic, optical, electromagnetic, infrared, and/or semiconductor system (or apparatus or device). In some embodiments, the computer-readable storage medium 704 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer-readable storage medium 704 includes a compact disk read-only memory (CD-ROM), a compact disk-read/write (CD-R/W) memory, and/or a digital video disc (DVD) memory.

In some embodiments, the computer-readable storage medium 704 stores computer program code 706 configured to cause the EDA system 700 (where such execution represents (at least in part) the EDA tool) to be usable for performing a portion or all of the noted processes and/or methods. In some embodiments, the computer-readable storage medium 704 also stores information that facilitates performing a portion or all of the noted processes and/or methods. In some embodiments, the computer-readable storage medium 704 stores process data 708 including, in some embodiments, control algorithms, process variables and constants, target ranges, set points, and code for enabling statistical process control (SPC) and/or model predictive control (MPC) based control of the various processes.

In the EDA system 700, the I/O interface 712 is coupled to external circuitry. In some embodiments, the I/O interface 712 includes a keyboard, keypad, mouse, trackball, trackpad, touchscreen, and/or cursor direction keys for communicating information and commands to the processor 702.

The network interface 714 coupled to the processor 702. The network interface 714 allows the EDA system 700 to communicate with network 716, to which one or more other computer systems are connected. In some embodiments, the network interface 714 includes one or more wireless network interfaces such as BLUETOOTH, WIFI, WIMAX, GPRS, WCDMA, or the like, and/or one or more wired network interfaces such as ETHERNET, USB, IEEE-1364, or the like. In some embodiments, a portion or all of noted processes and/or methods is implemented in two or more EDA systems 700.

The EDA system 700 is configured to receive information through the I/O interface 712. The information received through the I/O interface 712 includes one or more of instructions, data, design rules, process performance histories, target ranges, set points, and/or other parameters for processing by the processor 702. The information is transferred to the processor 702 via the bus 718. EDA system 700 is configured to receive information related to a user interface (UI) through the I/O interface 712. The information is stored in the computer-readable storage medium 704 as user interface (UI) 710.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 700.

In some embodiments, the processes are realized as functions of a program stored in a non-transitory computer-readable recording medium. Examples of a non-transitory computer-readable recording medium include external/removable and/or internal/built-in storage or memory units, e.g., one or more of an optical disk such as a DVD, a magnetic disk such as a hard disk, a semiconductor memory such as a ROM, a RAM, a memory card, or the like.

As set forth herein, one or more embodiments provide systems and methods for improving electromigration sign-off methodologies in conjunction with the analysis of IC designs by taking into consideration both self-heating effects and thermal coupling between heat-generating structures (e.g., self-heating transistors, active regions, Hi-R structures, conductive lines, and the like) and temperature-affected structures (e.g., transistors, active regions, Hi-R structures, conductive lines and the like), to provide more accurate estimates of the performance and lifetime of semiconductor devices manufactured according to such IC designs.

The following U.S. Patents and U.S. Patent Application Publications are hereby incorporated by reference in their entireties: U.S. Pat. Nos. 10,867,109, 11,288,437, 11,687,698, U.S. Patent Appl. Pub. 2023/0334220 A1, U.S. Pat. Nos. 11,107,714, 11,658,049, U.S. Patent Appl. Pub. 2023/0290658 A1, U.S. Pat. No. 11,256,847, and U.S. Patent Appl. Pub. 2022/0147692 A1.

According to some embodiments, a method of evaluating a heat effect in an integrated circuit (IC) design includes identifying a structure of interest in the IC design; assigning a thermal affected zone to a region of the IC design, such that the thermal affected zone encompasses at least a portion of the structure of interest; identifying a plurality of structures that are, in whole or in part, in the thermal affected zone and that correspond to IC device elements that self-heat during operation of an IC device that is based on the IC design; modeling a corresponding plurality of operating temperatures for the plurality of structures and identifying, among the plurality of operating temperatures, a highest temperature; identifying, among the plurality of structures, a structure having the highest temperature as a first neighboring structure; assigning a rating factor based on a distance between the structure of interest and the first neighboring structure; and modeling an operating temperature of the structure of interest based on the highest temperature and the rating factor.

According to some embodiments, a method manufacturing an integrated circuit (IC) device includes identifying a structure of interest in a first IC design; assigning a thermal affected zone to a region of the first IC design, such that the thermal affected zone encompasses at least a portion of the structure of interest; identifying a plurality of structures that are, in whole or in part, in the thermal affected zone and that correspond to IC device elements that self-heat during operation of an IC device that is based on the first IC design; modeling a corresponding plurality of operating temperatures for the plurality of structures and identifying, among the plurality of operating temperatures, a highest temperature; identifying, among the plurality of structures, a structure having the highest temperature as a first neighboring structure; calculating a first temperature rise by multiplying the highest temperature by a temperature rise ratio, the temperature rise ratio being a number less than 1 and greater than 0; modeling a first operating temperature of the structure of interest; and evaluating a temperature-dependent electromigration parameter of the structure of interest at a second operating temperature, the second operating temperature being at least a sum of the first operating temperature and the first temperature rise.

According to some embodiments, a system for evaluating electromigration includes at least one memory configured to store device layout design data and device layout thermal equations; at least one processor configured to: access the at least one memory, and retrieve the device layout design data and the device layout thermal equations; generate a device layout design from the device layout design data; identify a structure of interest in the device layout design;

assign a thermal affected zone to a region of the device layout design, such that the thermal affected zone encompasses at least a portion of the structure of interest; identify a plurality of structures that are, in whole or in part, in the thermal affected zone and that correspond to device elements that self-heat during operation of a device that is based on the device layout design; model a corresponding plurality of operating temperatures for the plurality of structures and identify, among the plurality of operating temperatures, a highest temperature; identify, among the plurality of structures, a structure having the highest temperature as a first neighboring structure; assign a rating factor based on a distance between the structure of interest and the first neighboring structure; and model an operating temperature of the structure of interest based on the highest temperature and the rating factor.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of evaluating a heat effect in an integrated circuit (IC) design, the method comprising:
identifying a structure of interest in the IC design;
assigning a thermal affected zone to a region of the IC design, such that the thermal affected zone encompasses at least a portion of the structure of interest;
identifying a plurality of structures that are, in whole or in part, in the thermal affected zone and that correspond to IC device elements that self-heat during operation of an IC device that is based on the IC design;
modeling a corresponding plurality of operating temperatures for the plurality of structures and identifying, among the plurality of operating temperatures, a highest temperature;
identifying, among the plurality of structures, a structure having the highest temperature as a first neighboring structure;
assigning a rating factor based on a distance between the structure of interest and the first neighboring structure;
modeling an operating temperature of the structure of interest based on the highest temperature and the rating factor;
evaluating a temperature-dependent electromigration parameter of the structure of interest at the operating temperature of the structure of interest; and
generating a revised IC design by revising the IC design, the generating a revised IC design comprising revising an electrical current specification of the structure of interest, based on the evaluation of the temperature-dependent electromigration parameter.

2. The method of claim 1, wherein the structure of interest is a first conductive line, and the first neighboring structure is a second conductive line.

3. The method of claim 1, wherein:
the modeling a corresponding plurality of operating temperatures for the plurality of structures includes:
modeling a temperature rise for the plurality of structures during operation of the IC device, and
the modeling an operating temperature of the structure of interest based on the highest temperature and the rating factor includes:
multiplying the temperature rise of the first neighboring structure by a number less than 1 and greater than 0.

4. The method of claim 1, further comprising:
dividing the thermal affected zone into a plurality of sub-zones, each sub-zone representing a different distance from the structure of interest, and
assigning a corresponding plurality of rating factors to the plurality of sub-zones.

5. The method of claim 4, wherein:
the assigning a rating factor based on a distance between the structure of interest and the first neighboring structure includes:
selecting the rating factor from among the plurality of rating factors.

6. The method of claim 4, wherein:
the plurality of rating factors includes a first rating factor, a second rating factor, and a third rating factor, the first rating factor corresponding to a shortest distance from the structure of interest among the first through third rating factors,
the first rating factor corresponds to a first number less than 1 and greater than 0,
the second rating factor corresponds to a second number less than 1 and greater than 0,
the third rating factor corresponds to a third number less than 1 and greater than 0,
the first number is greater than the second number, and
the second number is greater than the third number.

7. The method of claim 6, wherein:
a difference between the first number and the second number is greater than a difference between the second number and the third number.

8. The method of claim 4, wherein each sub-zone corresponds to a contacted poly pitch.

9. The method of claim 1, further comprising modeling an operating temperature of the structure of interest based on a highest temperature and a rating factor in the revised IC design.

10. The method of claim 1, further comprising generating a tape-out data file based on the revised IC design.

11. The method of claim 9, further comprising manufacturing an IC device based on the revised IC design.

12. A method of manufacturing an integrated circuit (IC) device, the method comprising:
identifying a structure of interest in a first IC design;
assigning a thermal affected zone to a region of the first IC design, such that the thermal affected zone encompasses at least a portion of the structure of interest;
identifying a plurality of structures that are, in whole or in part, in the thermal affected zone and that correspond to IC device elements that self-heat during operation of an IC device that is based on the first IC design;
modeling a corresponding plurality of operating temperatures for the plurality of structures and identifying, among the plurality of operating temperatures, a highest temperature;
identifying, among the plurality of structures, a structure having the highest temperature as a first neighboring structure;
calculating a first temperature rise by multiplying the highest temperature by a temperature rise ratio, the temperature rise ratio being a number less than 1 and greater than 0;
modeling a first operating temperature of the structure of interest;
evaluating a temperature-dependent electromigration parameter of the structure of interest at a second operating temperature, the second operating temperature being at least a sum of the first operating temperature and the first temperature rise;
revising an electrical current specification of the structure of interest, based on the evaluation of the temperature-dependent electromigration parameter; and
generating a second IC design by revising the first IC design to include the revised electrical current specification of the structure of interest.

13. The method of claim 12, further comprising:
modeling a second temperature rise of at least one of a transistor, an active region, or a Hi-R device during operation of the IC device,
wherein the second operating temperature is at least a sum of the first operating temperature, the first temperature rise, and the second temperature rise.

14. The method of claim 12, wherein the temperature rise ratio decreases with increasing distance between the structure of interest and the first neighboring structure.

15. The method of claim 12, wherein:
the thermal affected zone has a center located at the structure of interest, and
the temperature rise ratio has a minimum value at a location in the thermal affected zone that is farthest from the center.

16. The method of claim 12, further comprising:
modeling an operating temperature of the structure of interest based on a highest temperature and a rating factor in the second IC design.

17. The method of claim 16, further comprising:
manufacturing the IC device based on the second IC design.

18. A system for evaluating electromigration comprising:
at least one memory configured to store device layout design data and device layout thermal equations;
at least one processor configured to:
access the at least one memory, and retrieve the device layout design data and the device layout thermal equations;
generate a device layout design from the device layout design data;
identify a structure of interest in the device layout design;
assign a thermal affected zone to a region of the device layout design, such that the thermal affected zone encompasses at least a portion of the structure of interest;
identify a plurality of structures that are, in whole or in part, in the thermal affected zone and that correspond to device elements that self-heat during operation of a device that is based on the device layout design;
model a corresponding plurality of operating temperatures for the plurality of structures and identify, among the plurality of operating temperatures, a highest temperature;
identify, among the plurality of structures, a structure having the highest temperature as a first neighboring structure;
assign a rating factor based on a distance between the structure of interest and the first neighboring structure;
model an operating temperature of the structure of interest based on the highest temperature and the rating factor; and
generate a revised device layout design by revising the device layout design, the generating a revised device layout design including revising an electrical current specification of the structure of interest based on the evaluation of the temperature-dependent electromigration parameter.

19. The system of claim 18, wherein the at least one processor is further configured to:
evaluate a temperature-dependent electromigration parameter of the structure of interest at the operating temperature of the structure of interest.

20. The system of claim 19, wherein the at least one processor is further configured to:
model an operating temperature of the structure of interest based on a highest temperature and a rating factor in the revised device layout design.
